(19) United States
(12) Patent Application Publication
(10) Pub. No.: US 2014/0308999 A1
(43) Pub. Date: Oct. 16, 2014

(54) METHOD OF PLAYING A RICOCHET GAME

(71) Applicant: Arkady AIZENBERG, Glenview, IL (US)

(72) Inventor: Arkady AIZENBERG, Glenview, IL (US)

(21) Appl. No.: 13/860,049

(22) Filed: Apr. 10, 2013

(51) Int. Cl. A63F 13/00; A63F 7/00

(52) U.S. Cl. CPC A63F 13/005; A63F 7/0005; A63F 2300/206; A63F 2300/8011
USPC 463/3; 273/119 R

(57) ABSTRACT

A method, a computer readable recording medium, and a computer system for use in playing a ricochet game are presented. One variant of the method includes shooting cue balls against pool table rails and subsequently earning points by knocking over various pylons or even knocking billiard balls into pockets. The method can include the operational steps of fabdicating, acquiring, adding, amassing, deducting, garnering, getting, loosing, obtaining, positioning, putting, receiving, relinquishing, setting, shooting, starting, subtracting, surrendering, winning, and yielding. The computer readable recording medium includes coded instructions for the operational method steps. The computer system capable of simulating the play of the ricochet game is also described in which computer system includes a CPU, a memory, the computer readable recording medium, a display terminal and an input device.

### FIELD OF THE INVENTION

The present invention relates to games, more particularly to methods and computer systems for use in playing an enjoyable and challenging ricochet game which can knock down various upright pylons is described.

### DESCRIPTION OF THE PRIOR ART

A wide variety of shoot and knock down target skill games is currently available on the commercial market and an even larger number of these types of board, table and computer games are known in the art of shoot down games, for example the billiard-like game disclosed by Smith in U.S. Pat. No. 7,722,471 uses pool balls which are marked with chess piece indicia for playing a hybrid chess game. Another shoot and knock down target skill game known in the art is the game apparatus of Gholsom in U.S. Pat. No. 4,004,804 which discloses a billiard-like game for playing a golf-billiard hybrid game. Yet another billiard type game known in the arts is the shuffleboard billiards game of Thomas in U.S. Pat. No. 5,011,147 which incorporates a table shuffleboard having a centrally placed rail for forcing the player to ricochet the puck to hit various objects and locations within the table. Still yet another billiard type game known in the arts is the game target overlay for billiard table disclosed by Jones in U.S. Pat. No. 5,183,254 which uses an accessory planar overlay which carries special game target indicia. Even yet another billiard type game known in the arts is the billiards game disclosed by Swearman in U.S. Pat. No. 6,902,490 which provides sixteen balls with four colors for the players to pocket all their associated colored balls plus the eight ball.

While all of the above-described devices fulfill their respective, particular objectives and requirements, the aforementioned prior art disclosures do not describe or even hint at a method of playing a ricochet game having pylons placed along designated areas in a playing surface for challenging the players by allowing ricochets of secondary hit balls to knock down the various upright pylons. This combination of elements would specifically match the user's particular individual needs of making it possible to provide a means for playing a game which challenges the players by allowing ricochets of secondary hit balls to knock down the various upright pylons. The above-described patents make no provision for a method or even a computer system capable of simulated this presently presented ricochet method game.

Therefore, a need exists for a new and improved method for playing a game which challenges the players by allowing ricochets of secondary hit balls to knock down the various upright pylons. In this respect, the method according to the present invention substantially departs from the conventional concepts and designs of the prior art, and in doing so provides an apparatus primarily developed for the purpose of providing a convenient means for making it possible to provide means for allowing any number of players to play a ricochet game which is both enjoyable and challenging.

### SUMMARY OF THE INVENTION

Methods, computer readable recording media, and computer systems are for use in playing a ricochet game are presented in detail herein.

One variant of the presently described invention is a method which includes shooting cue balls against pool table rails and subsequently earning points by knocking over various pylons or even knocking billiard balls into pockets. The method can include the operational steps of fabdicating, acquiring, adding, amassing, deducting, garnering, getting, loosing, obtaining, positioning, putting, receiving, relinquishing, setting, shooting, starting, subtracting, surrendering, winning, and yielding. The computer readable recording medium includes coded instructions for the operational method steps. The computer system capable of simulating the play of the ricochet game is also described in which computer system includes a CPU, a memory, the computer readable recording medium, a display terminal and an input device.

One variant of the presently described invention is a non-transient computer readable recording medium may include coded instructions for the steps described in the method of playing the game.

One variant of the presently described invention is a computer system may include a central processing unit, a memory, a non-transient computer readable recording medium, a display terminal, a graphical user interface, an input device, and a power source.

In view of the foregoing disadvantages inherent in the known types of method games and associated computer systems now present in the prior art, the present invention provides an improved method, computer readable recording medium, as well as, a unique computer system, which will be described subsequently in great detail, is to provide a new and improved manner of playing an enjoyable ricochet game which is not anticipated, rendered obvious, suggested, or even implied by the prior art, either alone or in any combination thereof.

There has thus been outlined, rather broadly, the more important features of the invention in order that the detailed description thereof that follows may be better understood, and in order that the present contribution of the art may be better appreciated.

The presently described method may also include setting up the game which includes the steps of aligning, deploying, depositing, employing, locating, mounting, placing, reposing, standing, using, and utilizing.

Numerous aspects, features and advantages of the present invention will be readily apparent to those of ordinary skill in the art upon reading of the following detailed description of presently preferred, but nonetheless illustrative, embodiments of the present invention when taken in conjunction with the accompany drawings. In this respect, before explaining the current embodiment of the invention in detail, it is to be understood that the invention is not limited in its application to the details of construction and to the arrangements of the components set forth in the following description or illustrated in the drawings. The invention is capable of other embodiments and of being practiced and carried out in various ways. Also, it is to be understood that the phraseology and terminology employed herein are for the purpose of description and should not be regarded as limiting.

There has thus been outlined, rather broadly, the more important features of the invention in order that the detailed description thereof that follows may be better understood, and in order that the present contribution of the art may be better appreciated.

### BRIEF DESCRIPTION OF THE DRAWINGS

The invention will be better understood and aspects other than those set forth above will become apparent when consideration is given to the following detailed description thereof. Such description makes reference to the annexed drawings wherein:

FIG. 1 is a top plan view of an exemplary configuration of the game constructed in accordance with the principles of the present invention;

FIG. 2 is another top plan view of an exemplary configuration of he game 10 of the present invention;

FIG. 3 is a perspective view of an exemplary configuration of the pylons of the present invention;

FIG. 4 is a perspective view of an exemplary configuration of the computer system for use in playing the game of the present invention.

The same reference numerals refer to the same parts throughout the various figures.

### DETAILED DESCRIPTION OF THE PREFERRED EMBODIMENT

The following detailed embodiments presented herein are for illustrative purposes. That is, these detailed embodiments are intended to be exemplary of the present invention for the purposes of providing and aiding a person skilled in the pertinent art to readily understand how to make and use of the present invention.

Accordingly, the detailed discussion disclosing the various exemplary embodiments is not intended, nor is to be construed, to limit the metes and bounds of the patent protection afforded the present invention, in which the scope of patent protection is intended to be defined by the claims and their equivalents thereof. Therefore, embodiments not specifically addressed herein, such as adaptations, variations, modifications, and equivalent arrangements, should be and are considered to be implicitly disclosed by the illustrative embodiments and claims described herein and therefore fall within the scope of the present invention.

Further, it should be understood that, although steps of various the claimed methods may be shown and described as being in a sequence or temporal order, the steps of any such method are not limited to being carried out in any particular sequence or order, absent an indication otherwise. That is, the claimed method steps are to be considered to be capable of being carried out in any sequential combination or permutation order while still falling within the scope of the present invention.

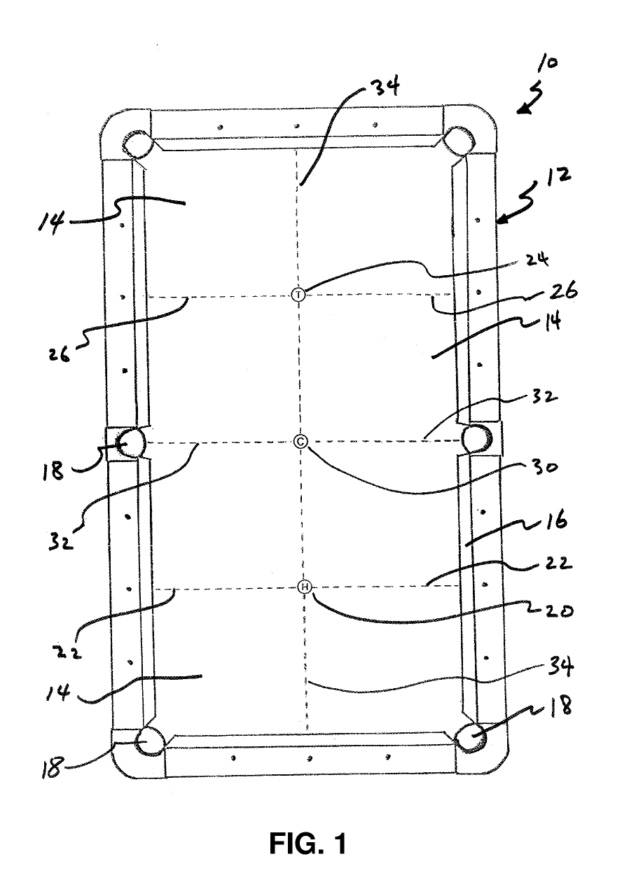

Referring now to the drawings, and in particular FIGS. 1 to 4 thereof, various preferred embodiments of the present invention are shown and generally designated the ricochet game being played by the reference numeral 10.

One exemplary embodiment of the method of playing a ricochet game 10 includes the game 10 steps of abdicating, acquiring, adding, amassing, deducting, garnering, getting, loosing, obtaining, positioning, putting, receiving, relinquishing, setting, shooting, starting, subtracting, surrendering, winning, and yielding.

The obtaining step can comprise obtaining the game 10 comprising: a playing arena 12 comprising: a playing surface 14; rails 16 surrounding the playing surface 14; pockets 18 between the ricochet rails 16; a head spot 20 on the playing surface 14; and a tail spot 24 on the playing surface 14; a direct action unit (DAU) 38; indirect action units (IAUs) 40; a plurality of pylons 36; and at least one shooter 42.

The setting step can comprise setting up the game 10 so that the pylons 36 are upright on the playing surface 14.

The positioning step can comprise positioning initially the DAU 38 on the playing surface 14 behind a head string line 22 on the playing surface 14.

The starting step can comprise starting play of the game 10 to propel the DAU 38 with the shooter 42, in which the DAU 38 is initially placed behind the head string line 22, so that the DAU 38 must cross both the head string line 22 and a center string line 32 in order to start the game 10.

The shooting step can comprise shooting with the shooter 42 to propel the DAU 38 along the playing surface 14.

The putting step can comprise putting back upright any pylons 36 that are knocked down after each shot of the shooter 42.

The receiving step can comprise receiving at least one pre-earned point when the propelled DAU 38 hits one of the IAUs 40 so that the hit IAU 40 ricochets off one of the rails 16 and that the hit IAU 40 subsequently knocks over anyone of the pylons 36.

The acquiring step can comprise acquiring at least one pre-earned point when the propelled DAU 38 hits both of the IAUs.

The garnering step can comprise garnering at least one pre-earned point when the propelled DAU 38 hits at least one of the IAUs 40 so that the hit IAU 40 ricochets off one of the rails 16 and that the hit IAU 40 subsequently falls into one of the pockets 18.

The getting step can comprise getting at least one pre-earned point when the propelled DAU 38 hits anyone of the IAUs 40 and that the hit IAU 40 falls into a pocket.

The amassing step can comprise amassing all pre-earned points into a player's score when the propelled DAU 38 hits one of the IAUs 40 so that the hit IAU 40 only ricochets off one of the rails 16.

The surrendering step can comprise surrendering one's turn when the propelled DAU 38 hits anyone of the IAUs 40 so that the hit IAU 40 only ricochets off at least one of the rails 16 without knocking over anyone of the pylons 36.

The yielding step can comprise yielding one's turn in the game 10 when the propelled DAU 38 falls into one of the pockets 18.

The loosing step can comprise loosing one's turn in the game 10 when the propelled DAU 38 hits and knocks over anyone of the pylons 36.

The abdicating step can comprise abdicating one's turn in the game 10 when the propelled DAU 38 fails to hit anyone of the IAUs.

The relinquishing step can comprise relinquishing one's turn in the game 10 when the propelled DAU 38 fits anyone of the IAUs 40 and the hit IAU 40 bounces off the rail 16 and the hit IAU 40 does not knock over any pylons 36, and the hit IAU 40 does not fall in anyone of the pockets 18.

The adding step can comprise adding any pre-earned points to the player's score when relinquishing one's turn in the game 10.

The deducting step can comprise deducting any pre-earned points from the player's score when the propelled DAU 38 falls into one of the pockets 18.

The subtracting step can comprise subtracting any pre-earned points from the player's score when the propelled DAU 38 hits and knocks over anyone of the pylons 36.

The winning step can comprise winning the play of the game 10 when the player's score is tallied to be equal to or greater than a predetermined integer.

The number of IAUs 40 may be any number such as 2, 3, 5, 9, and 12. One most preferred number of the IAUs 40 is that the number of IAUs 40 comprises two IAUs.

The predetermined integer may be any predetermined integers such as, 10, 11, 21, and 100. One most preferred variation of the predetermined integer is that it comprises the number twenty one.

The shooter 42 may be any known type of shooter 42 such as those selected from the group consisting of a pool stick, a hockey stick, a stick, a croquet mallet, a golf club, a shuffleboard paddle, a tennis racket, a cricket mallet, a racquetball racket, a glove, and a baseball bat. One preferred shooter 42 is that it is a pool stick.

The playing arena 12 may be any known type of playing area such as those selected from the group consisting of a carom table, a pool table, a billiard table, a snooker table, a bumper pool, an air hockey table, a tennis court, a racquetball court, and a fenced in lawn. One preferred playing area is that it is a pool table.

The DAU 38 may be any known type of DAU 38 such as those selected from the group consisting of cue ball, a baseball, a volleyball, basketball, a beach ball, a hockey puck, a shuffleboard puck, a golf ball, a ping pong ball, a soccer ball, a bowling ball, a racquetball, a croquet ball, and a tennis ball. One preferred DAU 38 is that it is a cue ball.

The IAUs 40 may be any known type of IAU 40 such as those selected from the group consisting of billiard balls, baseballs, hockey pucks, shuffleboard pucks, golf balls, ping pong balls, bowling balls, racquetballs, croquet balls, and tennis balls. One preferred variant of the IAUs 40 comprises two billiard balls.

The pylons 36 may be any known type of pylons 36 such as those selected from the group consisting of cone shaped pylons 36, cylindrical shaped pylons 36, elongated tetrahedral shaped pylons 36, elongated pyramidal shaped pylons 36, chess piece shaped pylons 36, skittle shaped pylons 36, and bowling pin shaped pylons 36.

The pylons 36 may be made of any known material such as those selected from the group consisting of metal, wood, plastic, foam, glass, ceramic and any combination thereof.

One preferred variant is that the pylons 36 are made of wood selected from the group consisting of acacia, alder, apple, ash, aspen, azobé, bamboo, beech, basswood, birch, buckeye, butternut, cedar, cherry, chestnut, cottonwood, cypress, elm, eucalyptus, fir, gum, hemlock, hickory, holly, iroko, keruing, larch, lacewood, locust, magnolia, mahogany, maple, merbau, mesquite, okoumé, pear, pine, poplar, redwood, rosewood, red oak, sapele, sassafras, spruce, sycamore, teak, walnut, willow, wenge, white oak, and yew.

The number of pylons 36 may be any number such as 1, 3, 5, or 7 in which one preferred number of pylons 36 comprises a total of 7 pylons 36. The size of the pylons 36 may be any size in which one preferred variant is that three of the pylons 36 are three and a half inches tall and four of the pylons 36 are two and a half inches tall

The pylons 36 may also include some sort of marking 44 for use in indicating a point value for knocking over the pylon.

Setting up the game 10 may comprise any number of different ways of setting up the game 10. One exemplary way of setting up the game 10 comprises the steps of aligning, deploying, depositing, employing, locating, mounting, placing, reposing, standing, using, and utilizing.

The locating sub-step of setting up the game 10 may comprise locating a center point 30 in the playing surface 14.

The using sub-step of setting up the game 10 may comprise using the center point 30, the head spot 20 and the tail spot 24 to define a long string line 34 lengthwise along the playing surface 14.

The employing sub-step of setting up the game 10 may comprise employing the head spot 20 to define the head string line 22 widthwise along the playing surface 14.

The utilizing sub-step of setting up the game 10 may comprise utilizing the tail spot 24 to define a tail string line 26 widthwise along the playing surface 14.

The deploying sub-step of setting up the game 10 may comprise deploying the center point 30 to define the center string line 32 widthwise along the playing surface 14.

The standing sub-step of setting up the game 10 may comprise standing upright one of the pylons 36 at the center point 30 of the playing surface 14.

The reposing sub-step of setting up the game 10 may comprise reposing upright four of the pylons 36 around the center point 30 so that all four pylons 36 are equidistant to the center point 30 and so that two of the four pylons 36 are on the center string line 32 and so that the other two of the four pylons 36 are on the long string line 34. One preferred reposing upright sub-step variation is that the four pylons 36 reposed upright around the center point 30 are all equidistant five inches away from the center point 30.

The depositing upright sub-step of setting up the game 10 may comprise depositing upright one of the pylons 36 behind the head string line 22 along the long string line 34. One preferred depositing upright sub-step variation is that deposited upright pylon 36 is five inches behind the head string line 22 along the long string line 34.

The placing upright sub-step of setting up the game 10 may comprise the placed upright pylons 36 which is placed upright five inches behind the tail string line 26 along the long string line 34.

The mounting sub-step of setting up the game 10 may comprise mounting one IAU 40 on the tail spot 24.

The aligning sub-step of setting up the game 10 may comprise aligning another one IAU 40 on the head spot 20.

Another exemplary embodiment is that the game 10 can be a non-transient computer readable recording (NTCRR) medium 46 that comprises coded instructions for carrying out the method of playing the ricochet game 10.

The NTCRR medium 46 can comprise coded instructions for displaying a playing arena 12 on a display terminal 54 54, such that the playing arena 12 comprises: a playing surface 14; rails 16 surrounding the playing surface 14; pockets 18 between the ricochet rails 16; a head spot 20 on the playing surface 14; and a tail spot 24 on the playing surface 14; a center point 30 in the playing surface 14; a long string line 34 which bisects lengthwise the playing surface 14 and which intersects the center point 30, the head spot 20 and the tail spot 24; a center string line 32 which bisects widthwise the playing surface 14 and which intersects the center point 30; a head string line 22 which bisects widthwise along the playing surface 14 and which intersects the head spot 20; and a tail string line 26 which bisects widthwise along the playing surface 14 and which intersects the tail spot 24.

The NTCRR medium 46 can also comprise coded instructions for displaying a direct action unit (DAU) 38 in the displayed playing arena 12 on the display terminal 54 54.

The NTCRR medium 46 can also comprise coded instructions for displaying a plurality of indirect action units (IAUs) 40 in the displayed playing arena 12 on the display terminal 54 54.

The NTCRR medium 46 can also comprise coded instructions for displaying a plurality of pylons 36 in the displayed playing arena 12 on the display terminal 54 54.

The NTCRR medium 46 can also comprise coded instructions for displaying at least one shooter 42 on the display terminal 54.

The NTCRR medium 46 can also comprise coded instructions for displaying one of the pylons 36 standing upright at the center point 30 of the displayed playing arena 12 on the display terminal 54.

The NTCRR medium 46 can also comprise coded instructions for displaying four of the pylons 36 positioned upright around the center point 30 in the displayed playing arena 12 on the display terminal 54, so that all four pylons 36 are equidistant to the center point 30 and so that two of the four pylons 36 are on the center string line 32 and so that the other two of the four pylons 36 are on the long string line 34.

The NTCRR medium 46 can also comprise coded instructions for displaying one of the pylons 36 deposited upright behind the head string line 22 along the long string line 34 in the displayed playing arena 12 on the display terminal 54.

The NTCRR medium 46 can also comprise coded instructions for displaying one of the pylons 36 placed upright behind the tail string line 26 along the long string line 34 in the displayed playing arena 12 on the display terminal 54.

The NTCRR medium 46 can also comprise coded instructions for displaying one IAU 40 mediumounted on the tail spot 24 in the displayed playing arena 12 on the display terminal 54.

The NTCRR medium 46 can also comprise coded instructions for displaying another one IAU 40 aligned on the head spot 20 in the displayed playing arena 12 on the display terminal 54.

The NTCRR medium 46 can also comprise coded instructions for displaying the DAU 38 to be positioned initially on the playing surface 14 behind the head string line 22 in the displayed playing arena 12 on the display terminal 54.

The NTCRR medium 46 can also comprise coded instructions for starting play of the game 10 to propel the DAU 38 with the shooter 42, in which the DAU 38 is initially placed behind the head string line 22, so that the DAU 38 must cross both the head string line 22 and a center string line 32 in order to start the game 10.

The NTCRR medium 46 can also comprise coded instructions for displaying shooting with the shooter 42 to propel the DAU 38 along the playing surface 14.

The NTCRR medium 46 can also comprise coded instructions for displaying putting back upright any pylons 36 that are knocked down after each shot of the shooter 42.

The NTCRR medium 46 can also comprise coded instructions for receiving at least one pre-earned point when the propelled DAU 38 hits one of the IAUs 40 so that the hit IAU 40 ricochets off one of the rails 16 and that the hit IAU 40 subsequently knocks over anyone of the pylons 36.

The NTCRR medium 46 can also comprise coded instructions for acquiring at least one pre-earned point when the propelled DAU 38 hits both of the IAUs.

The NTCRR medium 46 can also comprise coded instructions for garnering at least one pre-earned point when the propelled DAU 38 hits at least one of the IAUs 40 so that the hit IAU 40 ricochets off one of the rails 16 and that the hit IAU 40 subsequently falls into one of the pockets 18.

The NTCRR medium 46 can also comprise coded instructions for getting at least one pre-earned point when the propelled DAU 38 hits anyone of the IAUs 40 and that the hit IAU 40 falls into a pocket.

The NTCRR medium 46 can also comprise coded instructions for amassing all pre-earned points into a player's score when the propelled DAU 38 hits one of the IAUs 40 so that the hit IAU 40 only ricochets off one of the rails 16.

The NTCRR medium 46 can also comprise coded instructions for surrendering one's turn when the propelled DAU 38 hits anyone of the IAUs 40 so that the hit IAU 40 only ricochets off at least one of the rails 16 without knocking over anyone of the pylons 36.

The NTCRR medium 46 can also comprise coded instructions for yielding one's turn in the game 10 when the propelled DAU 38 falls into one of the pockets 18.

The NTCRR medium 46 can also comprise coded instructions for relinquishing one's turn in the game 10 when the propelled DAU 38 hits and knocks over anyone of the pylons 36.

The NTCRR medium 46 can also comprise coded instructions for deducting any pre-earned points from the player's score when the propelled DAU 38 falls into one of the pockets 18.

The NTCRR medium 46 can also comprise coded instructions for subtracting any pre-earned points from the player's score when the propelled DAU 38 hits and knocks over anyone of the pylons 36.

The NTCRR medium 46 can also comprise coded instructions for reducing any pre-earned points from the player's score when the propelled DAU 38 hits anyone of the IAUs 40 and the hit IAU 40 falls into anyone of the pockets 18 without ricocheting off any of anyone of the rails 16.

The NTCRR medium 46 can also comprise coded instructions for winning the play of the game 10 when the player's score is tallied to be equal to or greater than a predetermined integer.

The NTCRR medium 46 may be any type of computer readable medium such as those selected from the group consisting of a floppy disc, a hard disc, a magnetic tape, a flash memory, a random access memory (RAM), a read only memory (ROM), a magneto-optic disc (MO), CD-ROM, CD-R, CD-RW, DVD-ROM, DVD-RAM and DVD-RW.

Another exemplary embodiment can include a computer system 48 for playing the ricochet game 10. The computer system 48 can comprise a central processing unit (CPU) 50; a memory 52, a NTCRR medium 46, a display terminal 54, a graphical user interface 56, an input device 58 and a power source 60.

The NTCRR medium 46 may be stored in the memory 52 of the computer system 48 or the NTCRR medium 46 can separate and distinct form the memory 52.

The display terminal 54 of the computer system 48 is coupled to the CPU 50.

The GUI 56 of the computer system 48 is coupled to the CPU 50.

The input device 58 of the computer system 48 is coupled to the GUI 56. The input device 58 of the computer system 48 may be any type of input device 58 such as those selected from the group consisting of a computer mouse, a trackball, a joystick, a keyboard, a game controller, a touch sensitive pad and combinations thereof.

The power source 60 of the computer system 48 is coupled to the CPU 50, the memory 52, the display terminal 54, the GUI 56 and the input device 58.

Referring now to FIG. 1, a top plan view of an exemplary configuration of the playing arena 12 of the game 10 is depicted as a standard pool table having a playing surface 14 with rails 16 surrounding the playing surface 14 and pockets 18 between the ricochet rails 16. Also shown are a head spot 20, a tail spot 24, and a center which can be used to define a long string line 34 lengthwise along the playing surface 14. The head spot 20 can be used to define a head string line 22 which is widthwise along the playing surface 14. The tail spot 24 can be used to define a tail string line 26 which is also widthwise along the playing surface 14. The center point 30 is also used to define a center string line 32 which is also widthwise along the playing surface 14.

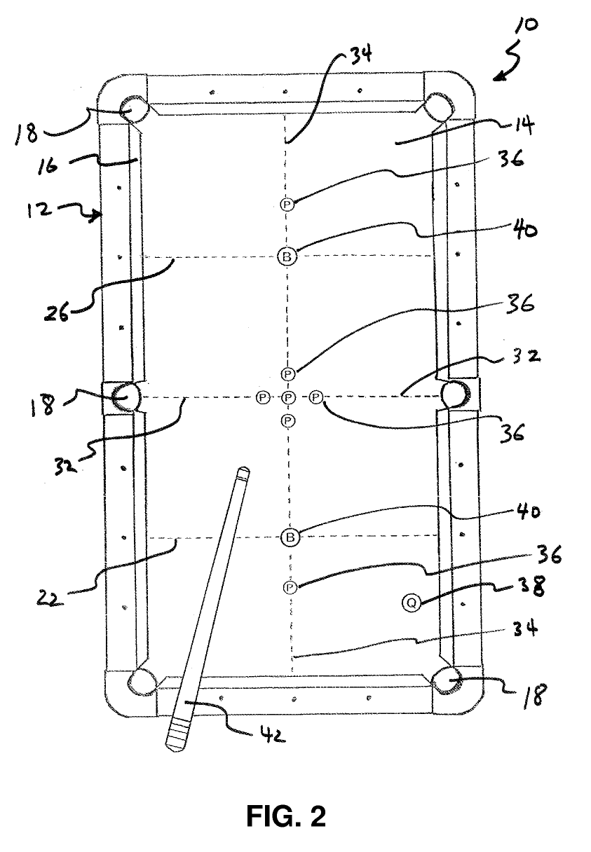

Referring now to FIG. 2, a top plan view of an exemplary configuration of the playing arena 12 of the game 10 is again depicted as a standard pool table having a playing surface 14 with rails 16 surrounding the playing surface 14 and pockets 18 between the ricochet rails 16. Also shown are the long string line 34, the head string line 22, the tail string line 26, and the center string line 32 on the playing surface 14. One of the pylons 36 is shown at the center point 30 of the playing surface 14. Four of the pylons 36 are shown around the pylon 36 at the center point 30 so that all four of these pylons 36 are equidistant to the center point 30 and so that two of the four pylons 36 are on the center string line 32 and so that the other two of the four pylons 36 are on the long string line 34. Another one of the pylons 36 is shown behind the head string line 22 on the long string line 34. Another one of the pylons 36 is shown behind the tail string line 26 on the long string line 34. The IAUs 40 in this exemplary pool table configuration are preferably standard billiard balls in which one IAU 40 is shown placed on the tail spot 24 and the other IAU 40 is shown placed on the head spot 20. Also the DAU 38 in this exemplary pool table configuration is preferably a standard cue ball in the DAU 38 is shown placed anywhere behind the head string line 22 on the playing surface 14. Also in this exemplary pool table configuration the shooter 42 is preferably a standard pool stick in which the shooter 42 is shown lain on the playing surface 14.

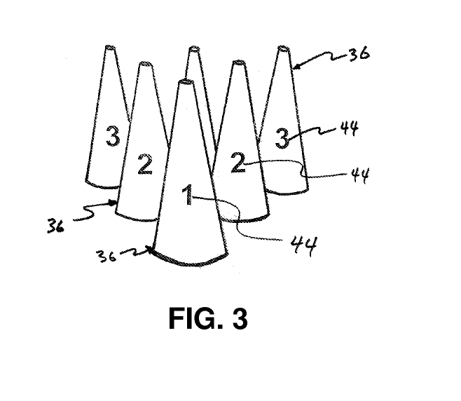

Referring now to FIG. 3, is a perspective view of an exemplary configuration of the pylons 36 which are cone shaped. As noted above, the pylons 36 may be any known shape such as those selected from the group consisting of cones, cylinders, elongated tetrahedrons, elongated pyramids, skittle shapes, bowling pin shapes, and even shaped as various chess pieces. It is important to note that the shape of the pylons 36 is not that important as long as the pylons 36 can be physically knocked over. It is also important to note that the number of pylons 36 can be any number in which seven are preferred. Also shown are markings 44 on the pylons 36 for use in indicating various point values for the knocked down pylons 36.

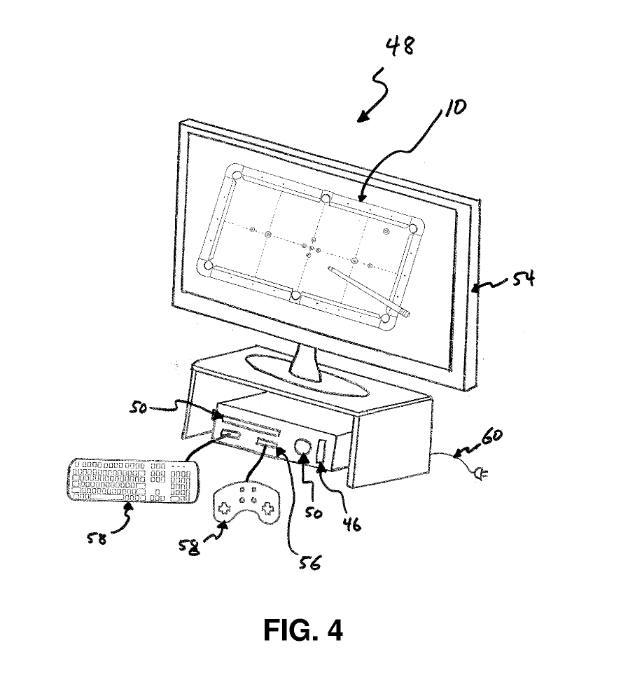

Referring now to FIG. 4, is a perspective view of an exemplary configuration of the computer system 48 for use in playing the game 10. The computer system 48 is shown being composed of a central processing unit (CPU) 50; a memory 52, a non-transient computer readable recording (NTCRR) medium 46, a display terminal 54, a graphical user interface 56, an input device 58 and a power source 60.

As to the manner of usage and operation of the present invention, the same should be apparent from the above description. While a preferred number of embodiments of the game method, the computer readable recording medium and the computer system device have been described in detail, it should be apparent that modifications and variations thereto are possible, all of which fall within the true spirit and scope of the invention. With respect to the above description then, it is to be realized that the optimum dimensional relationships for the parts of the invention, to include variations in size, materials, shape, form, function and manner of operation, assembly and use, are deemed readily apparent and obvious to one skilled in the art, and all equivalent relationships to those illustrated in the drawings and described in the specification are intended to be encompassed by the present invention.

What is claimed is:

1. A method of playing a ricochet game, the method comprising:
obtaining the game comprising:
a playing arena comprising:
a playing surface;
rails surrounding the playing surface;
pockets between the ricochet rails;
a head spot on the playing surface; and
a tail spot on the playing surface;
a direct action unit (DAU);
indirect action units (IAUs);
a plurality of pylons; and
at least one shooter;
setting up the game so that the pylons are upright on the playing surface;
positioning initially the DAU on the playing surface behind a head string line on the playing surface;
starting play of the game to propel the DAU with the shooter, in which the DAU is initially placed behind the head string line, so that the DAU must cross both the head string line and a center string line in order to start the game;
shooting with the shooter to propel the DAU along the playing surface;
putting back upright any pylons that are knocked down after each shot of the shooter;
receiving at least one pre-earned point when the propelled DAU hits one of the IAUs so that the hit IAU ricochets off one of the rails and that the hit IAU subsequently knocks over anyone of the pylons;
acquiring at least one pre-earned point when the propelled DAU hits both of the IAUs;
garnering at least one pre-earned point when the propelled DAU hits at least one of the IAUs so that the hit IAU ricochets off one of the rails and that the hit IAU subsequently falls into one of the pockets;
getting at least one pre-earned point when the propelled DAU hits anyone of the IAUs and that the hit IAU falls into a pocket;
amassing all pre-earned points into a player's score when the propelled DAU hits one of the IAUs so that the hit IAU only ricochets off one of the rails;
surrendering one's turn when the propelled DAU hits anyone of the IAUs so that the hit IAU only ricochets off at least one of the rails without knocking over anyone of the pylons;
yielding one's turn in the game when the propelled DAU falls into one of the pockets;
loosing one's turn in the game when the propelled DAU hits and knocks over anyone of the pylons;
abdicating one's turn in the game when the propelled DAU fails to hit anyone of the IAUs;
relinquishing one's turn in the game when the propelled DAU fits anyone of the IAUs and the hit IAU bounces off the rail and the hit IAU does not knock over any pylons, and the hit IAU does not fall in anyone of the pockets;
adding any pre-earned points to the player's score when relinquishing one's turn in the game;
deducting any pre-earned points from the player's score when the propelled DAU falls into one of the pockets;
subtracting any pre-earned points from the player's score when the propelled DAU hits and knocks over anyone of the pylons;
winning the play of the game when the player's score is tallied to be equal to or greater than a predetermined integer.

2. The method of claim 1, wherein
the playing arena comprises a pool table;
the DAU comprises a cue ball;
the IAUs comprises two billiard balls;
the pylons comprise a total of 7 pylons and that three of the pylons are 3½ inches tall and four of the pylons are 2½ inches tall, and that each pylon has a marking for use in indicating a point value for each pylon;
the shooter comprises a pool stick.

3. The method of claim 1, wherein IAUs comprise two IAUs.

4. The method of claim 1, wherein predetermined integer comprises 21.

5. The method of claim 1, wherein the shooter is selected from the group consisting of a pool stick, a hockey stick, a stick, a croquet mallet, a golf club, a shuffleboard paddle, a tennis racket, a cricket mallet, a racquetball racket, a glove, and a baseball bat.

6. The method of claim 1 wherein the playing arena is selected from the group consisting of a carom table, a pool table, a billiard table, a snooker table, a bumper pool, an air hockey table, a tennis court, a racquetball court, and a fenced in lawn.

7. The method of claim 1, wherein the DAU is selected from the group consisting of cue ball, a baseball, a volleyball, basketball, a beach ball, a hockey puck, a shuffleboard puck, a golf ball, a ping pong ball, a soccer ball, a bowling ball, a racquetball, a croquet ball, and a tennis ball.

8. The method of claim 1, wherein the IAUs are selected from the group consisting of billiard balls, baseballs, hockey pucks, shuffleboard pucks, golf balls, ping pong balls, bowling balls, racquetballs, croquet balls, and tennis balls.

9. The method of claim 1, wherein the pylons are selected from the group consisting of cone shaped pylons, cylindrical shaped pylons, elongated tetrahedral shaped pylons, elongated pyramidal shaped pylons, chess piece shaped pylons, skittle shaped pylons, and bowling pin shaped pylons.

10. The game of claim 1, wherein the pylons are made of material selected from the group consisting of metal, wood, plastic, foam, glass, ceramic and any combination thereof.

11. The method of claim 1, wherein the pylons are made of wood selected from the group consisting of acacia, alder, apple, ash, aspen, azobé, bamboo, beech, basswood, birch, buckeye, butternut, cedar, cherry, chestnut, cottonwood, cypress, elm, eucalyptus, fir, gum, hemlock, hickory, holly, iroko, keruing, larch, lacewood, locust, magnolia, mahogany, maple, merbau, mesquite, okoumé, pear, pine, poplar, redwood, rosewood, red oak, sapele, sassafras, spruce, sycamore, teak, walnut, willow, wenge, white oak, and yew.

12. The method of claim 1, wherein setting up the game comprises:
locating a center point in the playing surface;
using the center point, the head spot and the tail spot to define a long string line lengthwise along the playing surface;
employing the head spot to define the head string line widthwise along the playing surface;
utilizing the tail spot to define a tail string line widthwise along the playing surface;
deploying the center point to define the center string line widthwise along the playing surface;
standing upright one of the pylons at the center point of the playing surface;
reposing upright four of the pylons around the center point so that all four pylons are equidistant to the center point and so that two of the four pylons are on the center string line and so that the other two of the four pylons are on the long string line;
depositing upright one of the pylons behind the head string line along the long string line;
placing upright one of the pylons behind the tail string line along the long string line;
mounting one IAU on the tail spot; and
aligning another one IAU on the head spot.

13. The method of claim 12 wherein reposing upright four of the pylons around the center point so that all four pylons are equidistant 5 inches away from the center point.

14. The method of claim 12, wherein depositing upright one of the pylons 5 inches behind the head string line along the long string line.

15. The method of claim 12, wherein placing upright one of the pylons 5 inches behind the tail string line along the long string line.

16. A non-transient computer readable recording (NTCRR) medium comprising coded instructions for carrying out a method of playing a ricochet shooting knock down game, the NTCRRM comprising:
coded instructions for displaying a playing arena on a display terminal, such that the playing arena comprises:
a playing surface;
rails surrounding the playing surface;
pockets between the ricochet rails;
a head spot on the playing surface; and
a tail spot on the playing surface;
a center point in the playing surface;
a long string line which bisects lengthwise the playing surface and which intersects the center point, the head spot and the tail spot;
a center string line which bisects widthwise the playing surface and which intersects the center point;
a head string line which bisects widthwise along the playing surface and which intersects the head spot; and
a tail string line which bisects widthwise along the playing surface and which intersects the tail spot;
coded instructions for displaying a direct action unit (DAU) in the displayed playing arena on the display terminal;
coded instructions for displaying a plurality of indirect action units (IAUs) in the displayed playing arena on the display terminal;
coded instructions for displaying a plurality of pylons in the displayed playing arena on the display terminal;
coded instructions for displaying at least one shooter on the display terminal;
coded instructions for displaying one of the pylons standing upright at the center point of the displayed playing arena on the display terminal;
coded instructions for displaying four of the pylons positioned upright around the center point in the displayed playing arena on the display terminal, so that all four pylons are equidistant to the center point and so that two of the four pylons are on the center string line and so that the other two of the four pylons are on the long string line;
coded instructions for displaying one of the pylons deposited upright behind the head string line along the long string line in the displayed playing arena on the display terminal;
coded instructions for displaying one of the pylons placed upright behind the tail string line along the long string line in the displayed playing arena on the display terminal;
coded instructions for displaying one IAU mounted on the tail spot in the displayed playing arena on the display terminal;
coded instructions for displaying another one IAU aligned on the head spot in the displayed playing arena on the display terminal;
coded instructions for displaying the DAU to be positioned initially on the playing surface behind the head string line in the displayed playing arena on the display terminal;
coded instructions for starting play of the game to propel the DAU with the shooter, in which the DAU is initially placed behind the head string line, so that the DAU must cross both the head string line and a center string line in order to start the game;
coded instructions for displaying shooting with the shooter to propel the DAU along the playing surface;
coded instructions for displaying putting back upright any pylons that are knocked down after each shot of the shooter;
coded instructions for receiving at least one pre-earned point when the propelled DAU hits one of the IAUs so that the hit IAU ricochets off one of the rails and that the hit IAU subsequently knocks over anyone of the pylons;
coded instructions for acquiring at least one pre-earned point when the propelled DAU hits both of the IAUs;
coded instructions for garnering at least one pre-earned point when the propelled DAU hits at least one of the IAUs so that the hit IAU ricochets off one of the rails and that the hit IAU subsequently falls into one of the pockets;
coded instructions for getting at least one pre-earned point when the propelled DAU hits anyone of the IAUs and that the hit IAU falls into a pocket;
coded instructions for amassing all pre-earned points into a player's score when the propelled DAU hits one of the IAUs so that the hit IAU only ricochets off one of the rails;
coded instructions for surrendering one's turn when the propelled DAU hits anyone of the IAUs so that the hit IAU only ricochets off at least one of the rails without knocking over anyone of the pylons;
coded instructions for yielding one's turn in the game when the propelled DAU falls into one of the pockets;
coded instructions for relinquishing one's turn in the game when the propelled DAU hits and knocks over anyone of the pylons;
coded instructions for deducting any pre-earned points from the player's score when the propelled DAU falls into one of the pockets;
coded instructions for subtracting any pre-earned points from the player's score when the propelled DAU hits and knocks over anyone of the pylons;
coded instructions for reducing any pre-earned points from the player's score when the propelled DAU hits anyone of the IAUs and the hit IAU falls into anyone of the pockets without ricocheting off any of anyone of the rails; and
coded instructions for winning the play of the game when the player's score is tallied to be equal to or greater than a predetermined integer.

17. The NTCRR medium of claim 16, wherein predetermined integer comprises 21.

18. The NTCRR medium of claim 16, wherein the NTCRR medium is selected from the group consisting of a floppy disc, a hard disc, a magnetic tape, a flash memory, a random access memory (RAM), a read only memory (ROM), a magneto-optic disc (MO), CD-ROM, CD-R, CD-RW, DVD-ROM, DVD-RAM and DVD-RW.

19. A computer system for playing the ricochet shooting knock down game, the computer system comprising:
a central processing unit (CPU);
a memory coupled to the CPU and to the NTCRR medium of claim 16;
a display terminal coupled to the CPU;
a graphical user interface (GUI) coupled to the CPU;
an input device coupled to the GUI; and
a power source coupled to the CPU, the memory, the display terminal, the GUI and the input device.

20. The computer system of claim 19 wherein the input device is selected from the group consisting of a computer mouse, a trackball, a joystick, a touch sensitive pad and combinations thereof.
